(19) United States
(12) Patent Application Publication
(10) Pub. No.: US 2015/0188109 A1
(43) Pub. Date: Jul. 2, 2015

(54) SEPARATOR FOR LITHIUM-SULFUR SECONDARY BATTERY

(71) Applicant: HYUNDAI MOTOR COMPANY, Seoul (KR)

(72) Inventors: Tae Young KIM, Suwon-si (KR); Dong Hui Kim, Suwon-si (KR); Kyoung Han Ryu, Yongin-si (KR)

(73) Assignee: HYUNDAI MOTOR COMPANY

(21) Appl. No.: 14/559,248

(22) Filed: Dec. 3, 2014

(30) Foreign Application Priority Data
Dec. 30, 2013 (KR) 10-2014-0167774

(51) Int. Cl. H01M 2/16; H01M 4/38; H01M 10/052

(52) U.S. Cl. CPC H01M 2/1686; H01M 2/162; H01M 2/1653; H01M 10/052; H01M 4/38; H01M 4/382

(57) ABSTRACT

A lithium-sulfur secondary battery includes a sulfur cathode, a lithium anode, an ionomer membrane, and a supplementary liquid separator. The lithium-sulfur battery comprises dual separators in which a separator is capable of sufficiently providing an electrolyte to the sulfur-conductor cathode of the lithium-sulfur battery, and the ionomer membrane is used at the lithium anode.

### CROSS-REFERENCE TO RELATED APPLICATION

This application claims under 35 U.S.C. §119(a) the benefit of priority to Korean Patent Application No. 10-2013-0167774 filed on Dec. 30, 2013, the entire contents of which are incorporated herein by reference.

### TECHNICAL FIELD

The present disclosure relates to a lithium-sulfur battery having dual separators, which comprises a separator being capable of sufficiently providing an electrolyte to a sulfur-conductor cathode of the lithium-sulfur battery, and an ionomer membrane being used at a lithium anode.

### BACKGROUND

Recently, a study for applying an ionomer membrane, which has been widely used in a fuel cell field, to a lithium-sulfur battery has been carried out in order to solve a shuttle effect and a decrease in Coulomb efficiency by preventing the movement of polysulfide. In the ionomer membrane, a SO₃H⁻ group of a perfluorosulfonic acid (PFSA) polymer membrane is replaced with Li.

In particular, when H⁺ ions are replaced with lithium in the membrane, and the membrane is used in a lithium-sulfur battery, high cation conductivity and a lithium transference number (nearly 1) is obtained, because it is chemically stable. In addition, the movement of polysulfide anion can be prevented, and thus, only Li⁺ can be transferred.

However, lithium polysulfide is dissolved by using a liquid electrolyte and lithium ions are transported, and there is no space for supplementing the electrolyte due to the use of a membrane separator. Thus, a cathode electrode having a low sulfur loading amount should be used, and especially, the lithium ion conductivity of the cathode electrode is significantly low (see FIG. 1).

Referring to a thesis “Application of lithiated Nafion ionomer film as functional separator for lithium-sulfur cells”, Journal of Power Sources 218 (2012) 163-167, Zhaoqing Jin, Kai Xie, Xiaobin Hong, Zongqian Hu, Xiang Liu (see FIG. 3), a reaction mechanism of a PFSA membrane is as follows.

—(CF₂CF₂)ₘ—(CF₂CF(OCF₂CF(CF₃)OCF₂—CF₂SO₃H))ₙ

[symbol]

—OCF₂CF(CF₃)OCF₂—CF₂SO₃Li(in the presence of a pendent side chain)

[symbol]

—SO₃⁻+Li⁺degradation(Li⁺ion transfer, generation of a —SO₃⁻ electric field)

According to the above mechanism, because of the blockage of polysulfide (PS) movement, a side reaction with a Li anode is inhibited, and the loss of active material is prevented, thus improving cell performance and life. However, there are some restrictions to increasing the cell energy density due to low lithium ion conductivity.

As a prior art for a separator of a secondary battery, KR 10-2012-0135808 discloses a lithium-sulfur battery including a hydrophilic polysulfide confining layer interposed between a cathode and a separator to prevent a polysulfide-based material from being lost from the surface of the cathode during discharge. The polysulfide confining layer has a perforated structure such that material transported in an electrolyte can be effectively dispersed during charge and discharge reactions. Polyethylene glycol (PEG) is grafted onto a porous polyethylene (PE) membrane to impart hydrophilicity to the surface of the membrane, followed by an oxygen plasma treatment to oxidize its surface. Then, the PEG which is grafted with silane is reacted to prepare a porous hydrophilic membrane with a PEG polymer brush attached to the surface of the porous PE membrane.

KR 10-2012-0104358 (WO 2011/084649) discloses a semi-solid half-flow-cell involving a multi-step galvanostatic charge/discharge of a LiCoO₂ suspension continuously flowing at 20.3 mL/min, which is separated from a stationary Li metal anode by a microporous separator film. The semi-solid half-flow-cell includes a redox energy storage device comprising a cathode active material, an anode active material, and an ion-permeable medium which separates the cathode and anode active materials.

KR 10-2005-0021131 discloses a method of preventing the loss of a sulfur electrode and improving electrical conductivity of a lithium-sulfur battery. According to the method, a separator coated with Au having good conductivity is used so as to dissolve the sulfur of a cathode into an anode, and thereby, preventing the loss of sulfur. However, the method does not supplement an electrolyte in combination with an ionomer membrane, in particular, a lithiated separator of a lithium-sulfur secondary battery.

The present disclosure provides a supplementary liquid structure for a PFSA membrane to increase battery capacity through the increase in a sulfur loading amount of a lithium-sulfur battery (see FIG. 2).

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to solve the above-described problems associated with prior art.

According to an exemplary embodiment of the present disclosure, a lithium-sulfur secondary battery includes a sulfur cathode, a lithium anode, an ionomer membrane, and a supplementary liquid separator.

In an aspect of the present disclosure, the ionomer membrane of the lithium-sulfur secondary battery is a perfluoro-sulfonic acid (PFSA) polymer membrane which is represented by Formula 1, in which H⁺ ion of a —SO₃H group is replaced with Li⁺:

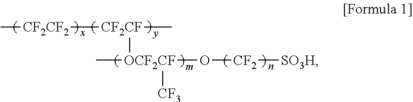

where m=0 or 1, n=0-5, x=0-15, and y=0-2, and the polymer membrane has an equivalent weight of 400-2000.

In another aspect of the present disclosure, the supplementary liquid separator of the lithium-sulfur secondary battery is located at a cathode side of the ionomer membrane.

The supplementary liquid separator of the lithium-sulfur secondary battery may be made with nonwoven fabrics, cellulose natural fibers, or one or more synthetic fibers selected from the group consisting of polyethylene (PE), polypropylene (PP), polytetrafluoroethylene (PTFE), and polyvinylidene fluoride (PVDF).

The supplementary liquid separator of the lithium-sulfur secondary battery may have an insulation coating layer on one or both sides of the supplementary liquid separator.

A loading amount of sulfur on the sulfur cathode of the lithium-sulfur secondary battery may be 7 mg/cm² or less.

The insulation coating layer of the lithium-sulfur secondary battery may be made with a polyolefin.

The supplementary liquid separator of the lithium-sulfur secondary battery may have an insulation coating layer inside thereof.

Other aspects and preferred embodiments of the invention are discussed infra.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present invention.

FIG. 1 is a diagram schematically illustrating a structure of a lithium-sulfur battery which employs only an ionomer membrane.

FIG. 2 is a diagram schematically illustrating a structure of a lithium-sulfur battery including a supplementary liquid separator.

FIG. 3 is a diagram schematically illustrating an internal structure of a lithium-sulfur battery as disclosed in the prior art.

FIGS. 4(A) and 4(B) are diagrams schematically comparing the lithium-sulfur battery of the present disclosure with the lithium-sulfur battery of the prior art.

FIG. 5 is a diagram schematically illustrating a manufacturing process of an ionomer membrane according to the present disclosure.

FIG. 6 is a photograph of a micro-structure of glass fiber nonwoven fabric that can be used as a supplementary liquid separator.

FIG. 7 is a diagram schematically illustrating a chemical reaction inside the lithium-sulfur battery to which a supplementary liquid separator and ionomer membrane are applied.

FIGS. 8(A)-8(D) are diagrams schematically illustrating exemplary embodiments of employing the supplementary liquid separator of the present disclosure.

FIG. 9 is a graph illustrating comparison results of capacity properties of the coin cells manufactured in Examples with those of the coin cell manufactured in Comparative Example.

FIG. 10 is a graph illustrating results of assessing life properties between a battery using the supplementary liquid separator of the present disclosure and a battery without the supplementary liquid separator.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawings.

### DETAILED DESCRIPTION

Hereinafter reference will now be made in detail to various embodiments of the present disclosure, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents, and other embodiments, which may be included within the spirit and scope of the invention as defined by the appended claims.

The present disclosure provides a lithium-sulfur secondary battery comprising a sulfur cathode, a lithium anode, an ionomer membrane, and a supplementary liquid separator.

The ionomer membrane is a perfluoro-sulfonic acid (PFSA) polymer membrane which can be represented by Formula 1 below, in which H⁺ ion of a —SO₃H group is replaced with Li⁺:

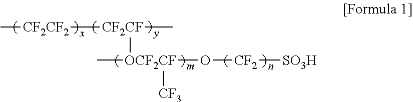

, where m=0 or 1, n=0-5, x=0-15, and y=0-2, in which the polymer has an equivalent weight of 400-2000.

The supplementary liquid separator may be located at a cathode side of the ionomer membrane, and has a porosity of 30-80% and a thickness of 30-300 μm.

The supplementary liquid separator can be made with nonwoven fabrics, cellulose natural fibers, or one or more synthetic fibers selected from the group consisting of polyethylene (PE), polypropylene (PP), polytetrafluoroethylene (PTFE), and polyvinylidene fluoride (PVDF). Both or one side of the supplementary liquid separator may include an insulation coating layer, and the insulation coating layer can be made with a polyolefin.

In addition, the insulation coating layer may be disposed inside of the supplementary liquid separator, and may be made with a polyolefin.

The lithium-sulfur secondary battery to which the supplementary liquid separator is applied according to the present disclosure can be manufactured by using a loading amount of sulfur on the sulfur cathode at maximum of 7 mg/cm².

In particular, an H⁺ cation of the PFSA polymer membrane is replaced with Li⁺ ion, to thereby form a lithiated ionomer membrane which can be applied as a separator to manufacture a lithium-sulfur cell. In order to manufacture the lithium-sulfur cell, the lithiated ionomer membrane is disposed between the cathode, which comprises sulfur and a conductor, and the lithium anode, followed by supplying an electrolyte thereinto. Here, there is no limitation to the kind and composition ratio of the sulfur, conductor, and binder so long as they are widely used in the art. The electrolyte may include carbonate-, ether-, ester-, and sulfone-based materials, and the like.

When a discharge reaction is carried out, anions of polysulfide cannot move toward the anode due to the generation of an electric field, and lithium ions can only move by hopping. As a result, by using the lithium ions, it is possible to prevent a side reaction of polysulfide with the lithium anode, the loss of an active material, and a shuttle effect of polysulfide.

If the supplementary liquid separator is not used, the cell may be manufactured by using a low loading amount of sulfur as the cathode (a loading amount of ˜1 mg/cm²) so as to obtain a desired capacity. In this case, since the loading amount of sulfur needs to be increased to enhance cell energy density, the use of only the ionomer membrane may not be adequate. Also, since ion-conduction of the ionomer membrane is achieved by the movement of the lithium ions only, ion conductivity is lower than the prior art.

A supplementary liquid separator structure according to the present disclosure is further applied to the PFSA polymer membrane, which results in increasing the sulfur loading amount of the lithium-sulfur battery, and thereby, enhances battery capacity (see FIG. 2). An ionomer separator has a backbone of —(CF₂CF₂)ₓ—(CF₂CF)_{y}. The ionomer separator may be manufactured by replacing H⁺ ion of a SO₃H group of the PFSA polymer membrane, which includes SO₃⁻ group as a side chain, with Li⁺ ion. The thickness of the ionomer separator may range from 10-100 μm. In certain embodiments, the thickness of the PFSA polymer membrane may be from 20-50 μm.

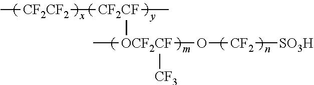

<Elementary Structure of PFSA Polymer Membrane>

In addition, the PFSA polymer membrane has a polymerization structure in which m=0, 1, n=0-5, x=0-15, and y=0-2, and a polymer membrane having an equivalent weight of 400-2000 may be used (see Table 1).

TABLE 1
Commercial PFSA Membranes

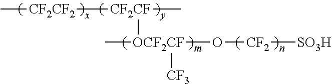

| | | | Thickness |
|---|---|---|---|
| Structure parameter | Trade name and type | Equivalent weight | (μm) |
| m = 1, x = 5-13.5, | DuPont | | |
| n = 2, y = 1 | Nation 120 | 1200 | 260 |
| | Nation 117 | 1100 | 175 |
| | Nation 115 | 1100 | 125 |
| | Nation 112 | 1100 | 80 |
| m = 0, 1, n = 1-5 | Asashi Glass | | |
| | Flemion-T | 1000 | 120 |
| | Flemion-S | 1000 | 80 |
| | Flemion-R | 1000 | 50 |
| m = 0, n = 2-5, | Asashi Chemicals | 1000-1200 | 25-100 |
| x = 1.5-14 | Aciplex-S | | |
| m = 0, n = 2, | Dow Chemical | 800 | 125 |
| x = 3.6-10 | Dow | | |

The H⁺ ion of the SO₃H functional group of the PFSA polymer membrane, which satisfies the requirements, is replaced with the Li⁺ ion by immersing the PFSA polymer membrane in a LiOH solution. During this process, the mass ratio of the PFSA polymer membrane and LiOH solution may be in a range of 1:3-1:1000.

If dual separators are used, because the supplementary liquid separator located at the cathode side is humidified with an electrolyte, it is possible to dissolve a sufficient amount of sulfur at a high sulfur loading at the cathode and convert it into polysulfide, thereby increasing the amount of lithium ions. The ionomer membrane, which is located behind the supplementary liquid separator, prevents the transfer of polysulfide anions. The ionomer membrane only transfers lithium ions, which are sufficiently dissolved in the cathode, to the anode. As a result, it is possible to overcome the problems of the side reaction caused by the contact of polysulfide with the lithium anode, the loss of an active material, and the like of the related art.

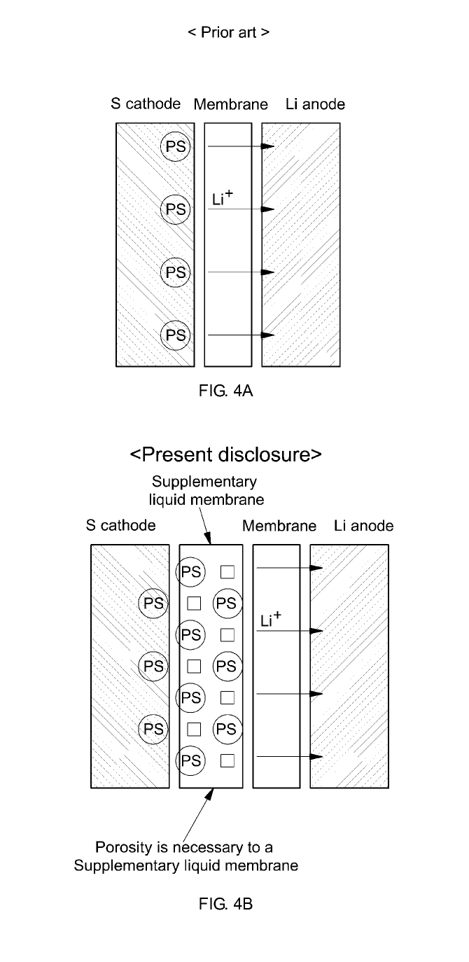

In order to solve the above-mentioned problems, the present disclosure has contrived a lithium-sulfur battery having dual separators capable of sufficiently supplementing an electrolyte to a sulfur-conductor cathode of the lithium-sulfur battery by using an ionomer membrane at a lithium anode (see FIGS. 4(A) and 4(B)).

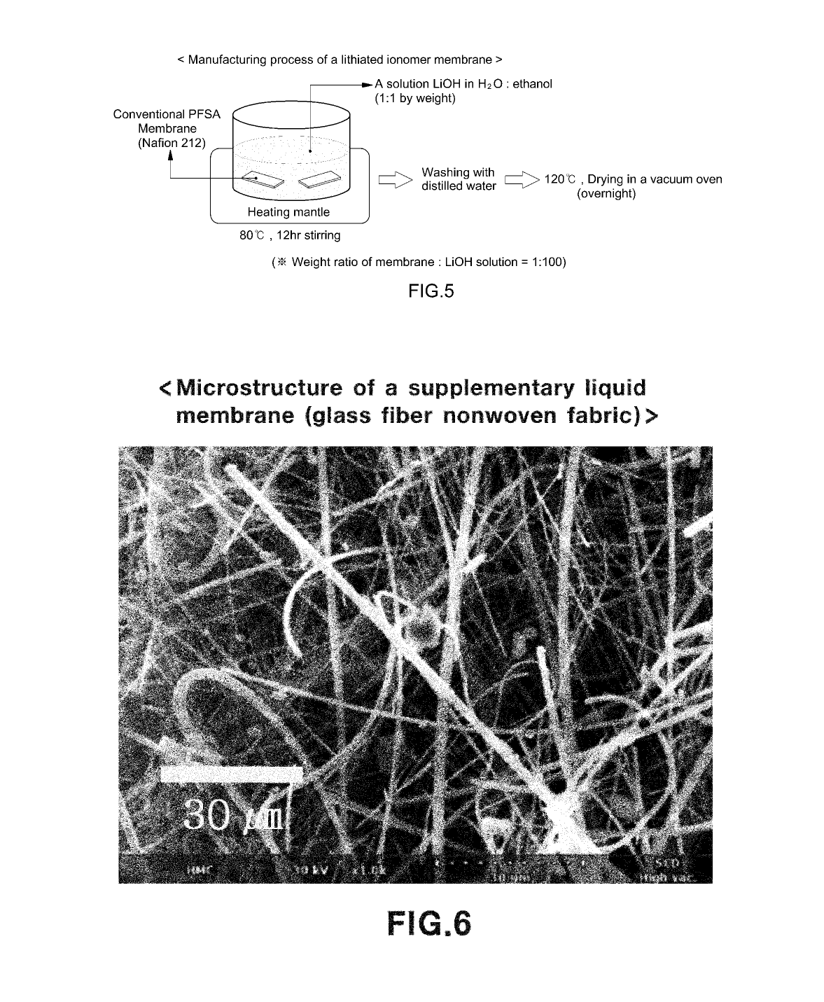

As previously described, the supplementary liquid separator may have a porosity of 30-80% and a thickness of 30-300 μm. The supplementary liquid separator may be made with chemically stable materials to an organic solvent (electrolyte) and located at the sulfur cathode side of the separator. The supplementary liquid separator may be made with a nonwoven fabric. FIG. 6 shows an example of the nonwoven fabric as glass fibers. Natural fibers (cellulose), and synthetic fibers (PE, PP, PTFE, PVDF) may also be used. In addition, for a shutdown function of the nonwoven fabric during thermal runaway, a coating layer at one side or both sides of the nonwoven fabric separator can be arranged to impart such a shutdown function when there is a temperature increase.

As described above, the present disclosure provides a lithium-sulfur battery having dual separators. One separator is an ionomer membrane which can move only lithium ions while blocking the movement of lithium polysulfide. The other separator is a supplementary liquid separator which shows similar effects to a solid electrolyte and is capable of supplementing a liquid electrolyte. The lithium-sulfur battery of the present disclosure can unexpectedly alleviated the problems associated with lithium-sulfur batteries of the related art, such as the shuttle effect of lithium polysulfide, a decrease in battery capacity and battery life due to the side reaction at the anode, an increase in a cell energy density at a low sulfur loading at the cathode, and the like.

The present invention has the following advantages over the prior arts:

1) Because the lithium-sulfur battery of the present disclosure contains a sufficient amount of electrolyte, desired battery functions are achieved even at a high sulfur loading amount per unit area (5-10 mg sulfur/cm²). Thus, when the sulfur loading amount per unit area is increased, an energy density based on the total weight of a cell is increased.

2) Due to a shutdown function of the nonwoven fabric separator having a coating layer inhibiting thermal runaway, safety is improved.

### EXAMPLES

The following examples illustrate the invention and are not intended to limit the same.

<Replacement of H⁺ Ions of a Conventional PFSA Polymer Membrane with Li⁺>

A LiOH aqueous solution and ethanol were mixed at mass ratio of 1:1 in a beaker, and Nafion 212 (Dupont), as a conventional PFSA polymer membrane, was soaked therein. The beaker was placed on a heating mantle, and then the mixture was heated to 80° C. for 12 hr or longer while continuously being stirred (see FIG. 5).

The higher the concentration of Li⁺ ions in the solution is, the easier the H⁺ ions of the membrane were replaced with Li⁺. In this Example, the replacement of Li⁺ was carried out under the condition that the mass ratio of the membrane and solution was 1:100. After the replacement was completed, the membrane was washed with distilled water to remove the residual salts thereon, and dried in a vacuum oven at 120° C. for 24 hr to manufacture an ionomer membrane in which H⁺ ions are replaced with Li⁺. The obtained ionomer membrane was vacuum-stored in a glove box.

<Manufacturing a Lithium-Sulfur Battery by Using an Ionomer Membrane and a Supplementary Liquid Separator>

After a separator for the supplementation of a liquid electrolyte was constructed at a sulfur cathode, a lithiated ionomer membrane and a lithium anode were orderly arranged to manufacture a cell.

### Examples 1-3

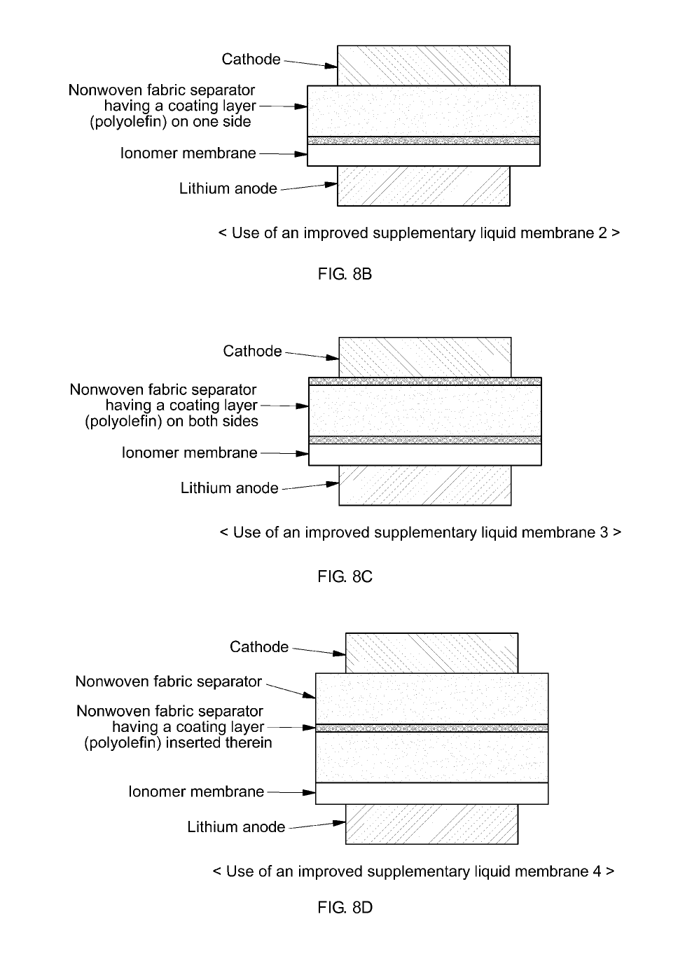

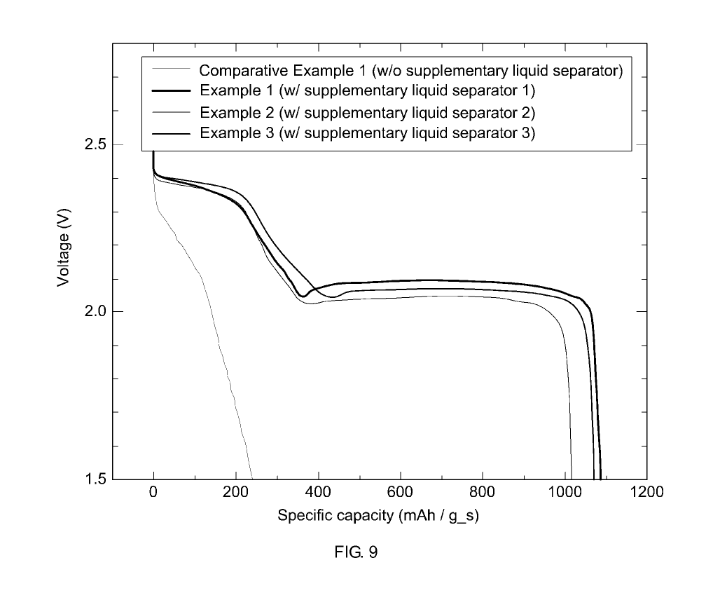

Sulfur, a conductive material (vapor grown carbon fiber (VGCF)), and a binder (PVDF) were mixed at a ratio of 70 wt %:20 wt %:10 wt % to prepare a slurry. The slurry was casted on an aluminum foil and dried at 80° C. for 24 hr to manufacture a cathode electrode with a particle size of 14 phi. An anode was prepared by using a lithium foil (100 micrometer in thickness) to have a size of 16 phi. A supplementary liquid separator and an ionomer membrane were simultaneously used as a separator. The ionomer membrane was placed on the lithium foil as an anode, the separator for the supplementation of an electrolyte was placed thereon, and then, the cathode electrode was placed thereon. After that, an electrolyte having 1 M lithium bis(trifluoromethane sulphone)imide (LiTFSI) in tetraethylene glycol dimethyl ether (TEGDME):dioxolane (DIOX) (1:1) was injected into the resulting construct, to thereby manufacture a coin cell as shown in FIG. 8(A)). The manufactured coin cell was subjected to charge-discharge measurements.

### Comparative Examples 1-2

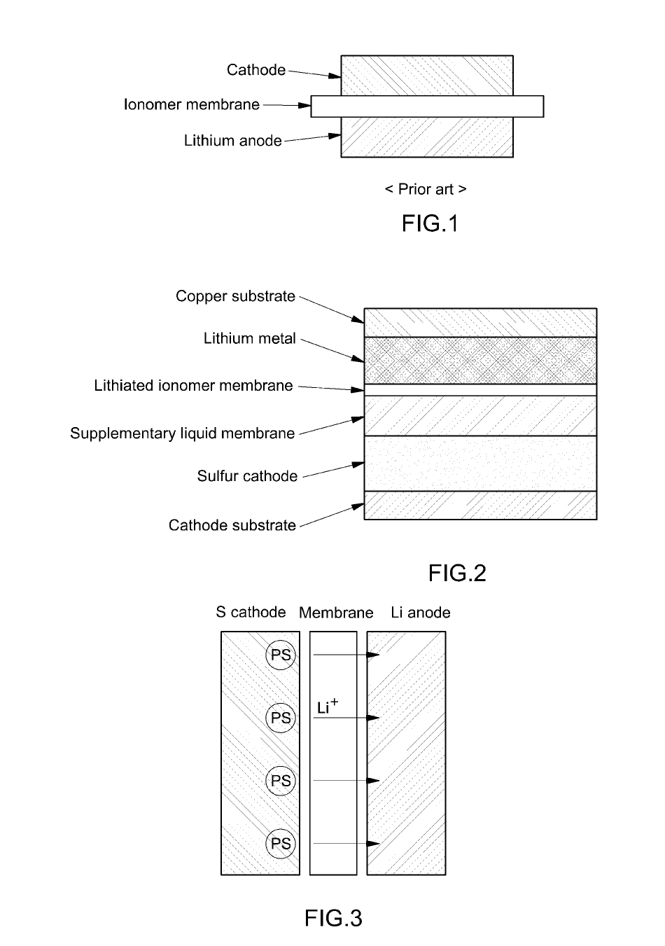

A slurry was prepared by mixing sulfur, a conductive material (VGCF) and a binder (PVDF) at a ratio of 70 wt %:20 wt %:10 wt %. The slurry was then casted on an aluminum foil and dried at 80° C. for 24 hr to manufacture a cathode electrode with a particle size of 14 phi. An anode was prepared by using a lithium foil (100 micrometer in thickness) to have a particle size of 16 phi. An ionomer membrane was solely used as a separator. The ionomer membrane was placed on the lithium foil as an anode, the cathode electrode was placed thereon, and then, an electrolyte having 1 M LiTFSI in TEGDME:DIOX (1:1) was injected thereinto to manufacture a coin cell (see FIG. 1). The manufactured coin cell was subjected to charge-discharge measurements.

The results of comparing capacity properties of the coin cells manufactured in Examples 1-3 employing the supplementary liquid separator of the high sulfur loading (loading amount of 5 mg/cm²) electrode with those of the coin cell manufactured in Comparative Example 1 are shown in the following Table 1 and FIG. 9.

TABLE 1

| | First discharge capacity | Discharge voltage |
|---|---|---|
| | (mAh/g) | (V) |
| Comparative | 207 | — |
| Example 1 | | |
| Example 1 | 1086 | 2.09 |
| Example 2 | 1015 | 2.05 |
| Example 3 | 1075 | 2.07 |

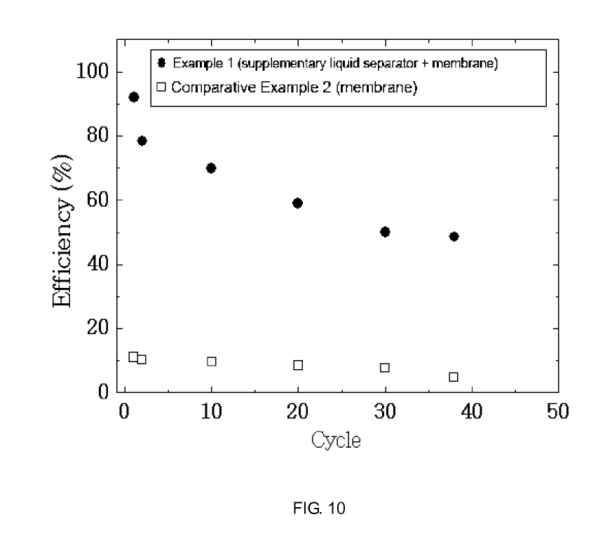

The results of assessing life properties between a battery using the supplementary liquid separator and a battery without the supplementary liquid separator are shown in the following Table 2 and FIG. 10.

TABLE 2

% Discharge capacity

| | 1 Cycle | 30 Cycle |
|---|---|---|
| Comparative | 11 | 7.7 |
| Example 2 | | |
| Example 1 | 92 | 50 |

In the absence of the supplementary liquid separator, the high sulfur loading electrode with a loading amount of 2 mg/cm² or higher did not show the same capacity and life properties as the battery with the supplementary liquid separator. However, it was found that when the membrane and supplementary liquid separator were simultaneously applied, the life properties of the high sulfur loading electrode were improved.

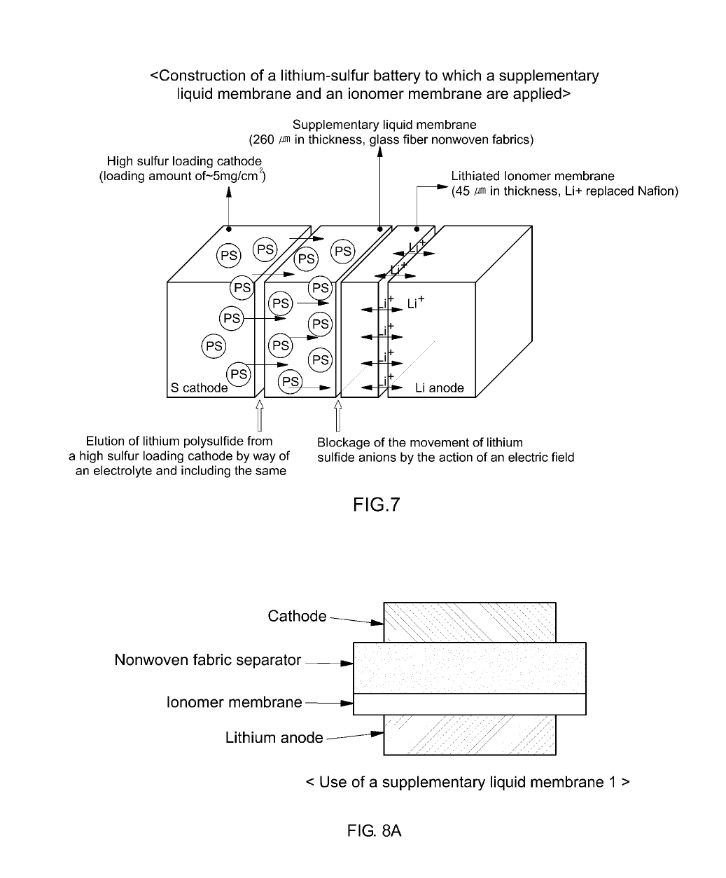

The use of the supplementary liquid separator makes it possible to employ the sulfur loading amount of the cathode at a various range from a low loading to a high loading (˜5 mg/cm²). The supplementary liquid separator causes lithium polysulfide be eluted from the sulfur cathode and is humidifies the sulfur cathode. The eluted lithium polysulfide cannot move toward the anode because it is blocked by the ionomer membrane, and only the lithium ion can move toward the anode (see FIG. 7). Therefore, the improvement of the energy density by applying a high loading of sulfur at the cathode, the prevention of a side reaction with a lithium anode and a shuttle effect of polysulfide through the blockage of the movement of polysulfide, and the increase in Coulomb effects can be expected.

The supplementary liquid separator of the present disclosure can be arranged each of (A)-(D) according to four embodiments as described in FIG. 8 (labeled as nonwoven fabric separator). The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A lithium-sulfur secondary battery comprising a sulfur cathode, a lithium anode, an ionomer membrane, and a supplementary liquid separator.

2. The lithium-sulfur secondary battery according to claim 1, wherein the ionomer membrane is a perfluoro-sulfonic acid (PFSA) polymer membrane which is represented by Formula 1, in which H⁺ ion of a —SO₃H group is replaced with Li⁺: 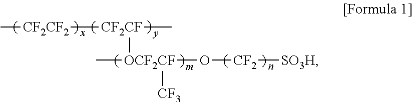
wherein m=0 or 1, n=0-5, x=0-15, and y=0-2, and the polymer has an equivalent weight of 400-2000.

3. The lithium-sulfur secondary battery according to claim 1, wherein the supplementary liquid separator is disposed at a cathode side of the ionomer membrane.

4. The lithium-sulfur secondary battery according to claim 1, wherein the supplementary liquid separator has a porosity of 30-80% and a thickness of 30-300 μm.

5. The lithium-sulfur secondary battery according to claim 1, wherein the supplementary liquid separator is made with nonwoven fabrics, cellulose natural fibers, or one or more synthetic fibers selected from the group consisting of polyethylene (PE), polypropylene (PP), polytetrafluoroethylene (PTFE), and polyvinylidene fluoride (PVDF).

6. The lithium-sulfur secondary battery according to claim 1, wherein the supplementary liquid separator has an insulation coating layer on one or both sides thereof.

7. The lithium-sulfur secondary battery according to claim 1, wherein a loading amount of sulfur on the sulfur cathode is 7 mg/cm² or less.

8. The lithium-sulfur secondary battery according to claim 6, wherein the insulation coating layer is made with a polyolefin.

9. The lithium-sulfur secondary battery according to claim 1, wherein the supplementary liquid separator has an insulation coating layer inside thereof.

10. The lithium-sulfur secondary battery according to claim 9, wherein the insulation coating layer is made with a polyolefin.

11. The lithium-sulfur secondary battery according to claim 2, wherein when a discharge reaction is carried out, lithium ions move by hopping.
